(19) United States
(12) Patent Application Publication
(10) Pub. No.: US 2005/0164077 A1
(43) Pub. Date: Jul. 28, 2005

(54) Pressure producing apparatus for an electrochemical generator

(76) Inventor: Bruno Bacon, Montreal (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 10/765,034

(22) Filed: Jan. 28, 2004

(51) Int. Cl. H01M 8/02

(52) U.S. Cl. 429/66; 429/37

(57) ABSTRACT

The invention provides an apparatus for maintaining a stack of electrochemical cells in an electrochemical generator in a state of compression. The apparatus includes a spring plate and a pressure plate, the spring plate being characterized by a series of resilient lateral extensions acting as springs. The pressure plate is operative to cooperate with the spring plate for applying pressure to the stack of electrochemical cells. Also provided is an electrochemical generator comprising a stack of electrochemical cells positioned within an enclosure and an apparatus positioned within the enclosure for maintaining the stack of electrochemical cells in a state of compression.

### FIELD OF THE INVENTION

The present invention relates to polymer batteries made from a plurality of laminated electrochemical cells and, more specifically, to a pressure producing apparatus adapted to maintain a minimum pressure on the laminated electrochemical cells in order to ensure optimal electrochemical performance.

### BACKGROUND OF THE INVENTION

Laminated electrochemical cells are typically arranged in a stack configuration and interconnected to form larger power producing devices, such as modules or batteries. A grouping of electrochemical cells may be selectively interconnected in a parallel and/or series relationship to achieve a desired voltage and current rating.

It has been determined that the performance and service-life of such modules or batteries are significantly improved by maintaining the layers of the stacked electrochemical cells in a state of compression. Improved cell performance may be realized by maintaining pressure on the two larger opposing surfaces of the cells during cell cycling. The thermal conduction characteristics of a stack of electrochemical cells are significantly improved when forced contact between adjacent cells is maintained. It is considered desirable that the compressive forces be distributed uniformly over the surface of application.

One factor that complicates the effective thermal and electrical conduction for thin-film electrochemical cells in a stack configuration is the cyclical changes in cell volume that occur during charge and discharge cycles. The volume of an electrochemical cell varies during charge and discharge cycling due to the migration of ions, for example lithium ions, into and out of the lattice structure of the cathode material. This migration causes a corresponding increase and decrease in total cell volume in the order of as much as ten percent during charging and discharging, respectively. The volume of the cells also fluctuates with temperature variation such that thermal dilatation and contraction may represent as much as a five percent increase and decrease, respectively, in total cell volume. In modules or batteries comprising numerous thin-film electrochemical cells in a stack configuration, the volume change is compounded such that the overall volume change is significant and must be accommodated.

In order to accommodate these compounded variations in electrochemical cell volume resulting from charge and discharge cycling of a grouping of cells, a pressure producing apparatus within the walls of the containment vessel of the battery is employed to maintain the cells in a continuous state of compression. An active pressure generating mechanism, such as a foam element or a spring-type element adjacent to the walls of the containment vessel is used to apply an evenly distributed pressure onto the outer surfaces of the outer cells of the cell stack during charge/discharge cycling. For large battery applications, the active pressure generating mechanism is typically comprised of a plurality of metal springs applying pressure against a metal plate which can generate the necessary compressive force, and may include spring inserts located between adjacent cells within the cell stack to enhance distribution of compressive forces within the cell stack.

Such pressure producing apparatuses are usually heavy, require assembly, and their costs substantially increase the overall cost of electrochemical cell batteries.

U.S. Pat. No. 6,087,036 describes various pressure producing apparatuses for stack configuration electrochemical cell batteries, where these pressure producing apparatuses suffer from the above mentioned drawbacks, namely, they are generally bulky and costly to produce and assemble.

Thus, it clearly appears that there is a need in the industry for a pressure producing apparatus that alleviates at least in part the shortcomings of previous pressure producing apparatuses adapted for electrochemical cell modules or batteries.

### SUMMARY OF THE INVENTION

It is therefore an object of the present invention to provide a pressure producing apparatus for an electrochemical generator that is cost effective and simple to manufacture and assemble.

It is another object of the present invention to provide an electrochemical generator including an improved pressure producing apparatus.

In accordance with a broad aspect, the invention provides an electrochemical generator comprising an enclosure and a stack of electrochemical cells positioned within the enclosure. The electrochemical generator further comprises an apparatus positioned within the enclosure for maintaining the stack of electrochemical cells in a state of compression. The apparatus includes at least one spring plate, the spring plate-being characterized by a series of resilient lateral extensions acting as springs.

In a specific example of implementation, the spring plate comprises a main body from which extends the series of resilient lateral extensions. The resilient lateral extensions are stamped out of the main body and extend from both sides of the main body in an alternating pattern. The spring plate is positioned between a rear plate and a pressure plate, where the pressure plate is characterized by a substantially flat surface for providing a substantially uniform pressure distribution on the stack of electrochemical cells.

In accordance with another broad aspect, the invention provides an apparatus for maintaining a stack of electrochemical cells in an electrochemical generator in a state of compression. The apparatus comprises a pressure plate and a spring plate, the spring plate being characterized by a series of resilient lateral extensions acting as springs. The pressure plate is operative to cooperate with the spring plate to apply pressure on the stack of electrochemical cells.

### BRIEF DESCRIPTION OF THE DRAWINGS

A detailed description of specific embodiments of the present invention is provided herein below with reference to the following drawings in which:

FIG. 1 is a schematic front cross-sectional view of an example of a typical electrochemical generator having a prior art pressure producing apparatus;

FIG. 2 is a schematic side cross-sectional view of the electrochemical generator having a prior art pressure producing apparatus and which is illustrated in FIG. 1;

FIG. 3 is a schematic front cross-sectional view of an example of a typical electrochemical generator having a pressure producing apparatus in accordance with a first embodiment of the invention;

FIG. 4 is a schematic front cross-sectional view of the electrochemical generator having a pressure producing apparatus in accordance with the first embodiment of the invention and which is illustrated in FIG. 3;

FIG. 5 is a perspective view of a spring plate in accordance with the first embodiment of the invention;

FIG. 6 is a cut-away perspective view of a pressure producing apparatus in accordance with the first embodiment of the invention;

FIG. 7 is a side cross-sectional view of a pressure producing apparatus in accordance with a second embodiment of the invention;

FIG. 8 is a cut-away perspective view, of a pressure producing apparatus in accordance with the second embodiment of the invention; and

FIG. 9 is a partial perspective view of a pair of spring plates in accordance with the second embodiment of the invention.

In the drawings, specific embodiments of the invention are illustrated by way of examples. It is to be expressly understood that the description and the drawings are only for the purpose of illustration and as an aid to understanding. They are not intended to be a definition of the limits of the invention.

### DETAILED DESCRIPTION

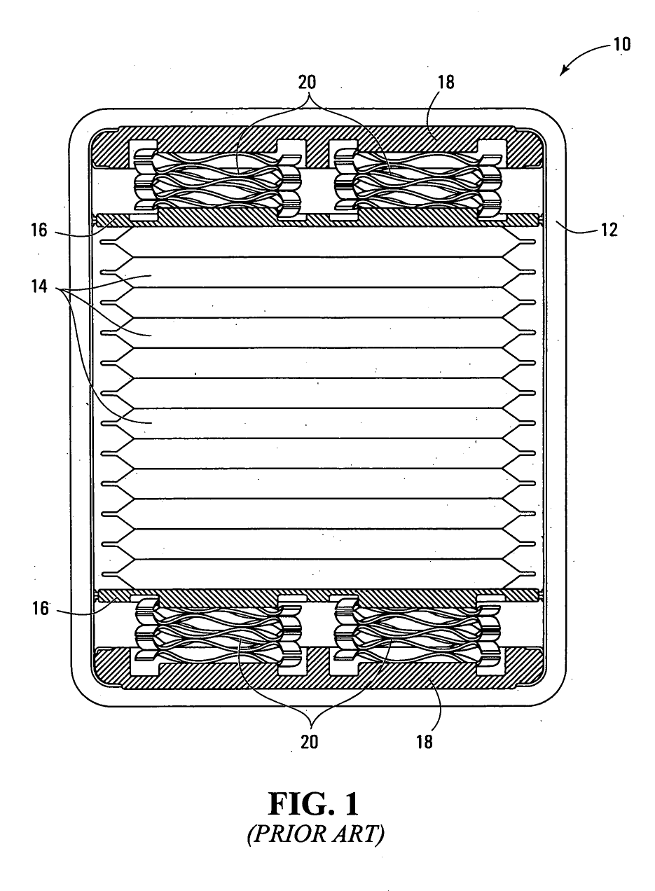

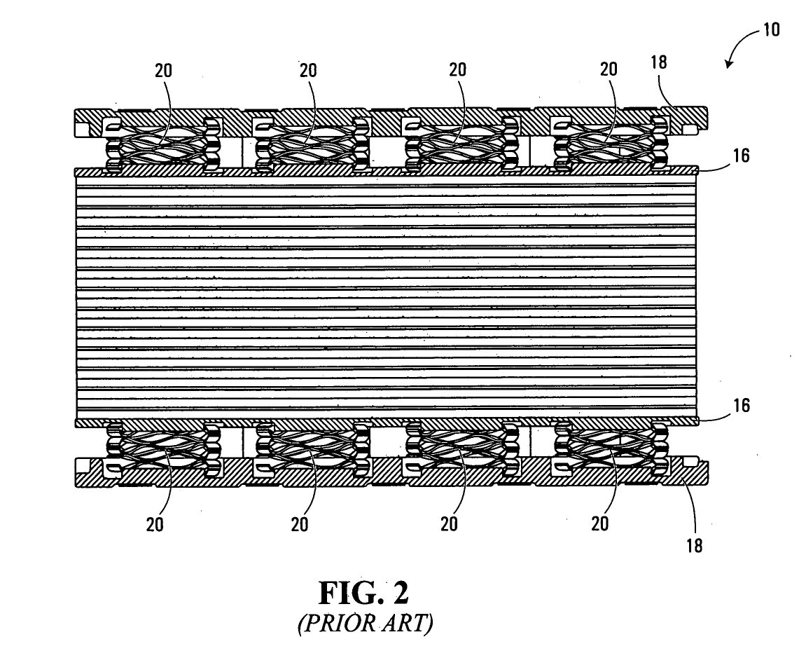

With reference to FIGS. 1 and 2, there is shown the front and lateral cross-sections of an example of a stacked electrochemical generator 10. The electrochemical generator 10 comprises a protective enclosure or casing 12 in which an array of electrochemical cells 14 are stacked together to form a battery. The electrochemical cells 14 may be electrically connected in series, in parallel or combination thereof depending on the desired voltage and current output. Each electrochemical cell 14 comprises an array of thin film laminates each comprising at least one negative sheet-like electrode (generally referred to as an anode), a positive sheet-like electrode (generally referred to as a cathode) on a current collecting element, and an electrolyte separator interposed between the anode and the cathode.

The performance and service-life of modules or batteries such as the electrochemical generator 10 are significantly improved by maintaining the stack of electrochemical cells 14 in a state of compression. An even distribution of pressure on the stack of electrochemical cells 14 increases the quality of the interface contacts between anode, separator and cathode of each laminate included in each electrochemical cell 14.

FIGS. 1 and 2 illustrate a typical embodiment of a prior art pressure producing apparatus comprising pressure plates 16, rear plates 18, and a series of coil springs 20 which apply a force on the pressure plates 16. The pressure plates 16 provide a reasonably well distributed compressive force on the stack of electrochemical cells 14. In the example illustrated in FIGS. 1 and 2, there are two series of eight coil springs 20 for a total of sixteen coil springs 20 for this particular pressure producing apparatus. The assembly of the pressure producing apparatus is therefore lengthy and the overall weight of sixteen coil springs is detrimental to the energy density of the electrochemical generator 10.

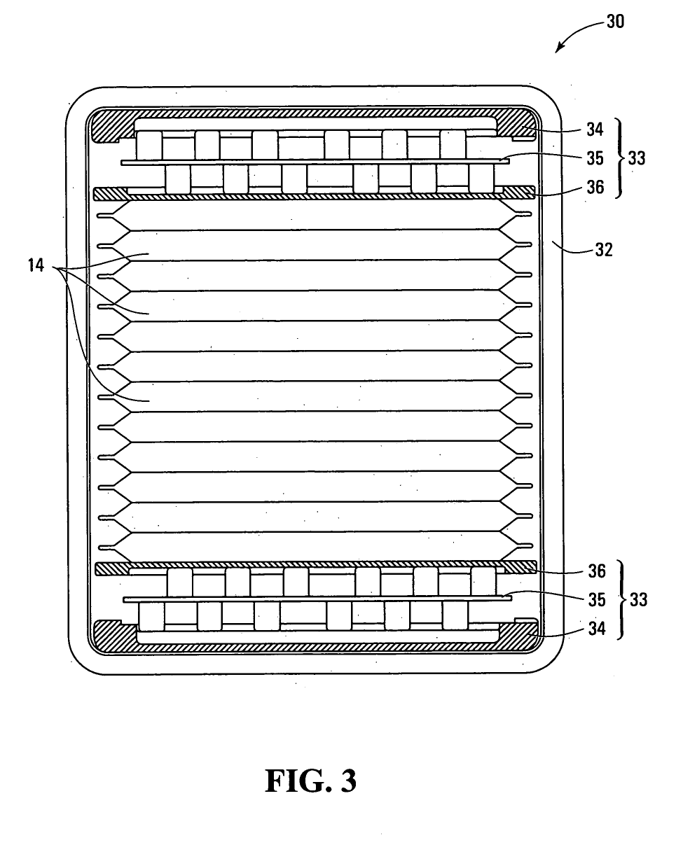

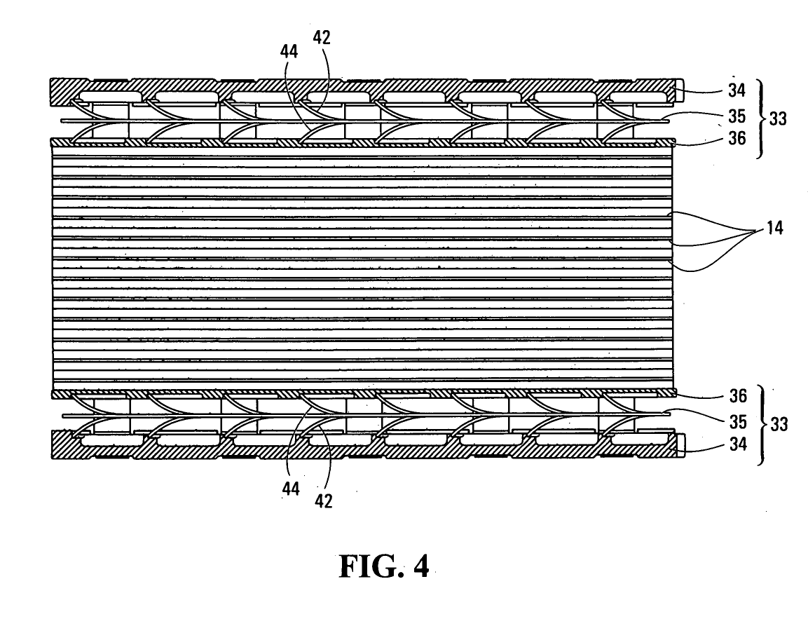

FIGS. 3 and 4 illustrate a stacked electrochemical generator in accordance with one embodiment of the present invention. The electrochemical generator 30 comprises a protective enclosure or casing 32 in which an array of electrochemical cells 14 are stacked together to form a battery. The electrochemical cells 14 may be electrically connected in series, in parallel or combination thereof depending on the desired voltage and current output. In the example shown, each electrochemical cell 14 comprises an array of thin film laminates each comprising at least one sheet-like anode, at least one sheet-like cathode on a current collecting element, and an electrolyte separator interposed between the anode and the cathode.

Specific to the present invention, the electrochemical generator 30 includes a pressure producing apparatus 33 positioned at each end of the stack of electrochemical cells 14, for maintaining the array of stacked electrochemical cells 14 in a state of compression. In a possible variant, the pressure producing apparatus 33 is positioned at only one of the ends of the stack of electrochemical cells 14. In the specific example shown in FIGS. 3 and 4, the pressure producing apparatus 33 is formed of a rear plate 34, a pressure plate 36, and a spring plate 35 located in between plates 34 and 36 which provides the compressive force required to maintain pressure on the surfaces at the two ends of the stack of electrochemical cells 14.

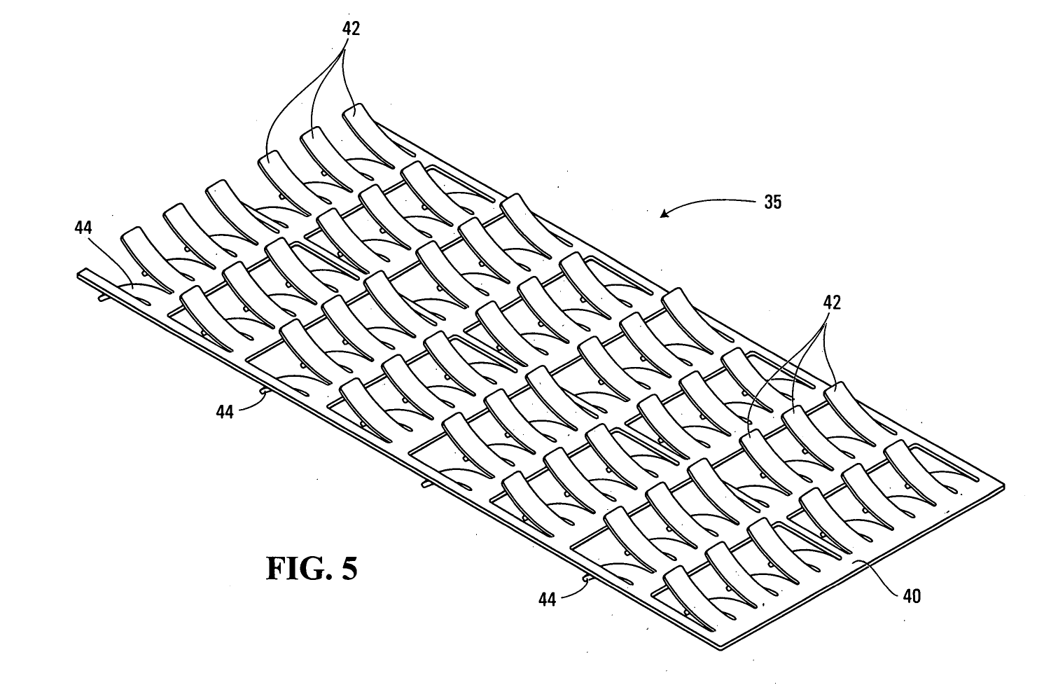

FIG. 5 is a perspective view of the spring plate 35 shown in the elevation views of FIGS. 3 and 4. Spring plate 35 consists of a main body 40, such as a flat metal plate, stamped to form a series of resilient lateral extensions or fingers 42 and 44 extending on both sides of the main body 40. When compressed or bent, the fingers 42 and 44 resist the deflection and act as springs. The fingers 42 and 44 are evenly distributed over the entire spring plate 35 in order to provide a uniform compressive force.

In the illustrated embodiment, fingers 42 and 44 are stamped out of flat metal plate 40 in an alternating pattern such that one finger 42 extending away from one side of plate 40 is followed by a finger 44 extending away from the other side of plate 40 to provide a uniform compressive force. In a specific example of implementation, spring plate 35 is made of stamped spring steel such as for example 1095 or 1075 carbon steel.

Advantageously, a single spring plate 35 replaces one series of coil springs 20 (shown in FIGS. 1 and 2) thereby substantially reducing the number of components, the assembly time, and the overall weight of the pressure producing apparatus according to the invention.

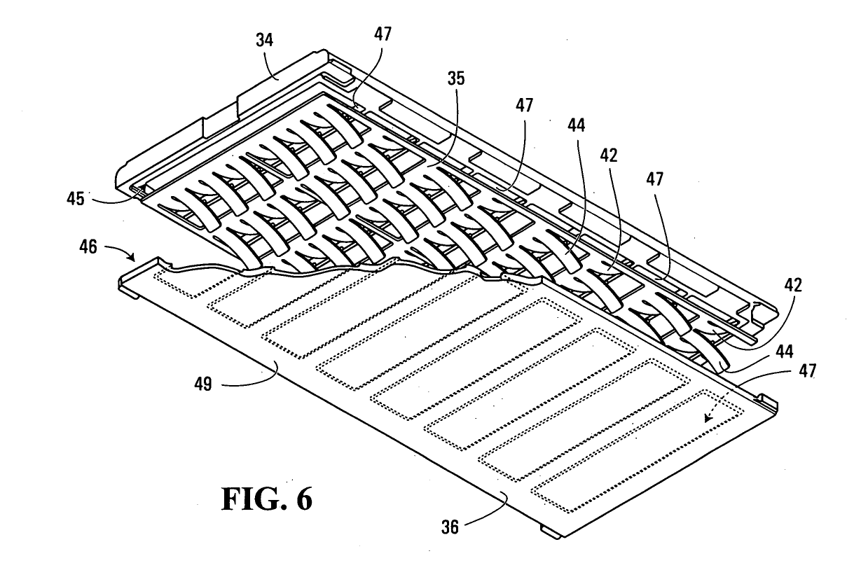

As illustrated in FIG. 6, the inner side 45 of each rear plate 34 is provided with receptacle tracks 47 adapted to anchor the ends of the fingers 42 and 44 of the spring plate 35. The inner side 46 of each pressure plate 36 is also provided with similar receptacle tracks 47 (shown in dotted lines). Receptacle tracks 47 provide for easy positioning of the rear plates 34 and pressure plates 36 relative to the spring plate 35 and therefore to the stack of electrochemical cells 14 and the enclosure 32. The outer sides 49 of the pressure plates 36, which are adjacent to the cell stack, are substantially flat in order to provide an even pressure distribution on the cell stack. The numbers of fingers 42 and 44 and specifically the number and distribution of fingers 44 applying pressure directly on the pressure plate 36 provides for a more even and uniform distribution of the force on the pressure plate 36 and therefore on the electrochemical cells 14 than that of the prior art springs 20 (shown in FIGS. 1 and 2).

To alleviate or compensate for potential uneven or irregular surfaces at the ends of the stack of electrochemical cells 14, thin foam sheets (not shown) may be positioned between the pressure plates 36 and the electrochemical cells 14. Such a thin foam sheet would fill the potential gaps that may exist between the rigid flat pressure plate 36 and the contact surface of the last electrochemical cell 14 of the stack (the one in contact with the pressure plate), thereby further insuring uniform distribution of the compressive force of spring plates 35 onto the entire surface of the stack.

Furthermore, because of the large number of contact points between spring plates 35 and pressure plates 36 provided by the fingers 44, the pressure plates 36 may be designed to be softer than the prior art pressure plates 16 (shown in FIGS. 1 and 2). A softer pressure plate 36 may be sufficiently malleable to conform to a marginally uneven surface of the end of the stack of electrochemical cells 14. In order to design softer pressure plates 36, the pressure plates 36 may be thinner and therefore lighter or made of a more ductile material.

In a variant to the embodiment of the pressure producing apparatus illustrated in FIGS. 3 to 6, it may be desirable to combine or superimpose two spring plates in order to increase the total travel of the pressure apparatus. As previously described, the volume of an electrochemical cell varies during charge and discharge cycling due to the migration of lithium ions into and out of the lattice structure of the cathode material and also to thermal dilatation. When numerous thin-film electrochemical cells are stacked together, the volume change is compounded such that the overall volume change is significant and must be accommodated. In order to accommodate these compounded variations in electrochemical cell volume resulting from charge and discharge cycling and thermal dilatation of a large grouping of cells, it may be necessary to combine or superimpose two spring plates between the rear plate and the pressure plate to maintain the electrochemical cells in a continuous state of compression.

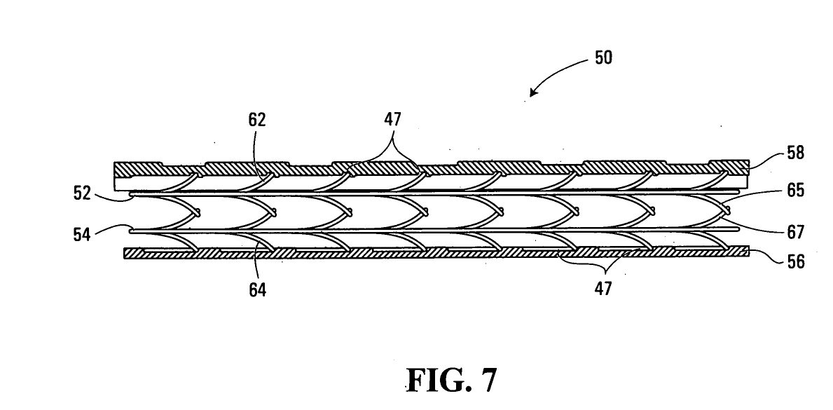

FIG. 7 is an elevational view showing a pressure producing apparatus 50 according to such a variant embodiment of the present invention. The pressure producing apparatus 50 comprises a pair of spring plates 52 and 54 positioned in between a pressure plate 56 and a rear plate 58, each comprising receptacle tracks 47 adapted to be anchored to the ends of the fingers 62 and 64 of the spring plates 52 and 54. In this particular embodiment, the ends of fingers 65 and 67 of each of the spring plates 52 and 54 are moored to each other via corresponding indents and/or seats designed at the ends of each finger 65 and 67.

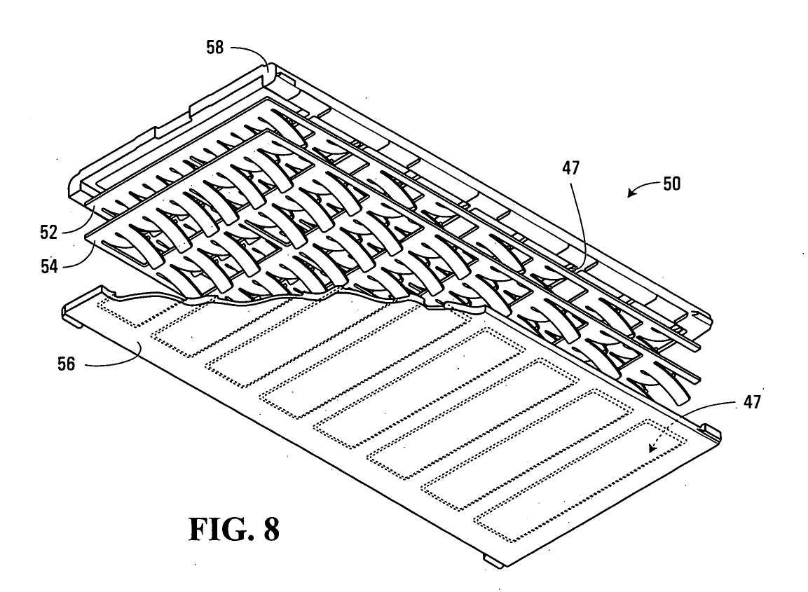

FIG. 8 is a perspective view of the pressure producing apparatus 50 of FIG. 7 illustrating the juxtaposed spring plates 52 and 54.

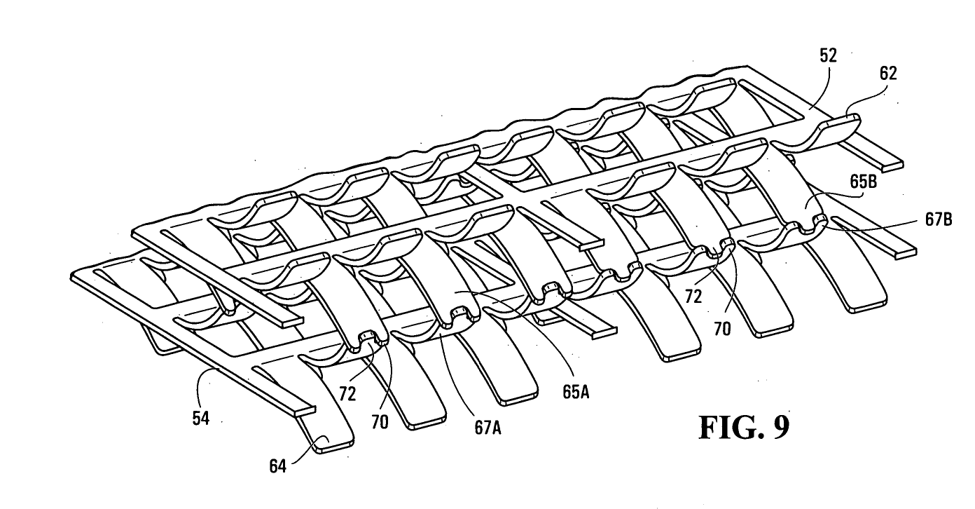

FIG. 9 illustrates one possible example of implementation of the mooring of fingers 65 and 67 together, wherein the ends of fingers 65 and 67 are provided with mating patterns enabling the superimposed spring plates 52 and 54 to be moored together. In the illustrated example, the ends of fingers 65A and 67B comprise rectangular indentations or seats 70 corresponding to rectangular profiles 72 extending from the ends of fingers 67A and 65B. Obviously, all variations of the concept of mating shapes mooring together to stabilize the two spring plates 52 and 54 is well within the reach of the person skilled in the art and therefore within the scope of the invention.

Although various embodiments have been illustrated, this was for the purpose of describing, but not limiting, the invention. Various modifications will become apparent to those skilled in the art and are within the scope of this invention, which is defined more particularly by the attached claims.

1. An electrochemical generator comprising:
an enclosure;
a stack of electrochemical cells positioned within said enclosure; and
an apparatus positioned within said enclosure for maintaining said stack of electrochemical cells in a state of compression, said apparatus including at least one spring plate characterized by a series of resilient lateral extensions acting as springs.

2. An electrochemical generator as defined in claim 1, wherein said spring plate comprises a main body from which extends said series of resilient lateral extensions.

3. An electrochemical generator as defined in claim 2, wherein the resilient lateral extensions extend from both sides of said main body.

4. An electrochemical generator as defined in claim 2, wherein the resilient lateral extensions are stamped out of said main body.

5. An electrochemical generator as defined in claim 4, wherein the resilient lateral extensions are stamped out of said main body from both sides of said main body in an alternating pattern.

6. An electrochemical generator as defined in claim 1, wherein said spring plate is made of a steel or alloys thereof.

7. An electrochemical generator as defined in claim 1, wherein said apparatus for maintaining said stack of electrochemical cells in a state of compression further includes a pressure plate, said pressure plate being operative to cooperate with said spring plate for applying pressure on said stack of electrochemical cells.

8. An electrochemical generator as defined in claim 7, wherein said pressure plate is positioned next to said stack of electrochemical cells and comprises a substantially flat surface adjacent said stack of electrochemical cells in order to provide a substantially uniform pressure distribution on said stack of electrochemical cells.

9. An electrochemical generator as defined in claim 8, further comprising a foam sheet located between said flat surface of said pressure plate and said stack of electrochemical cells.

10. An electrochemical generator as defined in claim 7, wherein said pressure plate comprises a series of receptacles adapted to anchor the ends of at least a subset of the resilient lateral extensions of said spring plate.

11. An electrochemical generator as defined in claim 7, wherein said apparatus for maintaining said stack of electrochemical cells in a state of compression further includes a rear plate, said spring plate being positioned between said rear plate and said pressure plate.

12. An electrochemical generator as defined in claim 11, wherein said rear plate comprises a series of receptacles adapted to anchor the ends of at least a subset of the resilient lateral extensions of said spring plate.

13. An electrochemical generator as defined in claim 1, wherein said apparatus for maintaining said stack of electrochemical cells in a state of compression is a first apparatus and is positioned adjacent one extremity of said stack of electrochemical cells, and wherein a second apparatus for maintaining said stack of electrochemical cells in a state of compression is positioned adjacent the other extremity of said stack of electrochemical cells.

14. An electrochemical generator as defined in claim 1, wherein said apparatus for maintaining said stack of electrochemical cells in a state of compression comprises a pair of superimposed spring plates thereby increasing the total travel of said apparatus.

15. An electrochemical generator as defined in claim 14, wherein the ends of the resilient lateral extensions of said pair of superimposed spring plates are provided with mating patterns enabling the superimposed spring plates to be moored together.

16. An apparatus for maintaining a stack of electrochemical cells in an electrochemical generator in a state of compression, said apparatus comprising:
a spring plate characterized by a series of resilient lateral extensions acting as springs;
a pressure plate operative to cooperate with said spring plate for applying pressure on the stack of electrochemical cells.

17. An apparatus as defined in claim 16, wherein said spring plate comprises a main body from which extends said series of resilient lateral extensions.

18. An apparatus as defined in claim 17, wherein the resilient lateral extensions extend from both sides of said main body.

19. An apparatus as defined in claim 17, wherein the resilient lateral extensions are stamped out of said main body.

20. An apparatus as defined in claim 19, wherein the resilient lateral extensions are stamped out of said main body from both sides of said main body in an alternating pattern.

21. An apparatus as defined in claim 16, wherein said pressure plate is characterized by a substantially flat surface for providing a substantially uniform pressure distribution on the stack of electrochemical cells.

22. An apparatus as defined in claim 16, wherein said pressure plate is characterized by a series of receptacles adapted to anchor the ends of at least a subset of the resilient lateral extensions of said spring plate.

23. An apparatus as defined in claim 16, wherein said apparatus further includes a rear plate, said spring plate being positioned between said rear plate and said pressure plate.

24. An apparatus as defined in claim 23, wherein said rear plate is characterized by a series of receptacles adapted to anchor the ends of at least a subset of the resilient lateral extensions of said spring plate.
